(19) United States
(12) Patent Application Publication
(10) Pub. No.: US 2025/0018550 A1
(43) Pub. Date: Jan. 16, 2025

(54) HAND-HELD TOOL AND FUNCTIONAL PART FOR A DETENT CONNECTION WITH A GRIP REGION OF A HAND-HELD TOOL

(71) Applicant: KNIPEX-Werk C. Gustav Putsch KG, Wuppertal (DE)

(72) Inventor: Filip MAROVIC, Wuppertal (DE)

(73) Assignee: KNIPEX-Werk C. Gustav Putsch KG, Wuppertal (DE)

(21) Appl. No.: 18/700,356

(22) PCT Filed: Nov. 8, 2022
(86) PCT No.: PCT/EP2022/081121

§ 371 Date: Apr. 11, 2024

(30) Foreign Application Priority Data
Nov. 8, 2021 (DE) 10 2021 129 001.5

(51) Int. Cl. B25G 1/08; B25B 7/22; B25B 15/02; B26B 11/00; B26B 13/22

(52) U.S. Cl. CPC B25G 1/08; B25B 7/22; B25B 15/02; B26B 11/008; B26B 13/22

(57) ABSTRACT

A hand-held tool has two tool parts which are arranged so as to cross one another in a joint region, each tool part forming a working region on one side of the joint region and a grip region on the other side. Each grip region is arranged in a first or second grip sleeve and the first and/or second grip sleeve is provided with a functional part. The first and/or second grip sleeve includes a passage opening extending in a longitudinal direction of the first and/or second grip sleeve and forming a first and/or second opening having a free opening cross-section. The functional part can be inserted into the passage opening in order to mount it on the first and/or second grip sleeve. The first and/or second opening is of substantially elongate rectangular design with respect to a cross-section transverse to a passage direction of the passage opening.

### CROSS REFERENCE TO RELATED APPLICATIONS

This application is the National Stage of PCT/EP2022/081121 filed on Nov. 8, 2022, which claims priority under 35 U.S.C. § 119 of German Application No. 10 2021 129 001.5 filed on Nov. 8, 2021, the disclosure of which is incorporated by reference. The international application under PCT article 21 (2) was not published in English.

### TECHNICAL FIELD

The invention pertains to a hand-held tool with a working region and a grip region, wherein the grip region is arranged in a grip sleeve, wherein the grip sleeve has an end assigned to the working region, as well as an opposite free end, and can be provided with a functional part, wherein the grip sleeve furthermore has a passage opening that extends in a longitudinal direction of the grip sleeve and forms a first opening, which also has a free opening cross section in an unused state, and a second opening, and wherein the functional part can be inserted into said passage opening in order to be mounted on the grip sleeve.

The invention furthermore pertains to a functional part for a detent connection with a grip region of a hand-held tool, wherein the functional part has an engagement section for engaging into a mounting recess of the grip region and a functional section, and wherein the engagement section furthermore is designed in the form of a flat region that is adapted to a passage opening with an essentially rectangular opening cross section.

### PRIOR ART

Hand-held tools of the type in question are known, for example, in the form of pliers such as universal pliers, side-cutting pliers or also water pump pliers, as well as in the form of scissors such as household scissors or pruning shears. The grip regions are provided with grip sleeves. These grip sleeves typically are realized in the form of plastic grip sleeves that may be manufactured in a plastic injection molding process. In this respect, hand-held tools are known, in which the grip sleeves are manufactured, particularly injection-molded, separately and then pushed over the grip regions. In other known solutions, direct overmolding of the grip regions is carried out. Furthermore, grip sleeves manufactured in a two-component injection molding process are known, wherein these grip sleeves accordingly have soft and hard plastic zones that can be advantageously gripped.

The potential arrangement of a functional part on the grip sleeve is furthermore known, wherein said functional part may be designed, for example, for promoting or also for preventing the function of the hand-held tool, e.g. in the form of a spring element or a locking strap. Such a functional part may also have a function that is completely independent of the function of the hand-held tool that is provided with this grip sleeve carrying the functional part, e.g. if the functional part is designed in the form of an LED light or in the form of a contactless strain gauge.

With respect to pliers known from the prior art, we also refer, in particular, to EP 5 282 52 A1 (U.S. Pat. No. 5,845,551 A), EP 0 421 107 A2, DE 39 29 323 C2, WO 2021/160598 A1, DE 10 2020 103 467 A1, DE 10 2018 123 705, WO 2019/207054 A1 (US 2021/0167586 A1) and WO 2018/146191 A1 (US 2020/0009750 A1). DE 10 2017 101 197 A1 discloses a hand-held tool with a grip sleeve and a functional part arranged on the grip sleeve, wherein said functional part particularly has a pivotable wire hanger, e.g. for suspending the hand-held tool. To this end, the functional part is bonded or welded on the grip sleeve.

U.S. Pat. No. 7,468,674 B2 discloses a hand-held tool with a grip sleeve, in which an attachment part to be pushed onto a grip sleeve is provided, wherein said attachment part has two corresponding openings, namely one opening for the grip sleeve and another opening for the functional part. US 2014/0013544 A1 discloses a hand-held tool, the metallic grip region of which is encompassed by a loop part, in which a second loop part is mounted in order to fasten a functional part.

EP 2 489 480 A2 discloses a hand-held tool, in which a passage opening is formed in one of the grip sleeves and a spring element is accommodated in said passage opening. The first opening has an opening cross section that points toward the opposite grip sleeve of the pliers-like tool and is formed distant from the free end of the grip region at approximately half the length of the grip region.

U.S. Pat. No. 5,680,697 A discloses a hand-held tool, in which two slots are formed in the grip region, wherein said slots form passage openings perpendicular to the longitudinal extent of the grip sleeve. A grounding cable to be connected to the hand-held tool is inserted through a first slot and inserted back through the second slot.

FR 1 111 365 B discloses a functional part with a clamp-like design for encompassing a metallic end region of a grip of pliers near the joint, wherein said end region essentially is bent in a U-shaped manner. The functional section has a flat design. The engagement section has a uniform leg. A right angle is formed between the insertion section and the functional section. The functional part serves for blocking a closed position of the pliers.

A grip sleeve of a hand-held tool, in which an insertion opening in the form of a blind bore for receiving a memory wire is formed, is known from DE 90 05 272 U1.

### SUMMARY OF THE INVENTION

Based on the above-described prior art, the invention aims to design a hand-held tool of the type in question advantageously with respect to the accommodation of a functional part in the grip sleeve, as well as to disclose a hand-held tool with such a functional part and an advantageously designed functional part of the aforementioned type.

According to a first inventive idea, the above-defined objective with respect to the hand-held tool is attained in that the first and the second opening essentially have an elongate rectangular design with respect to a cross section transverse to a passage direction of the passage opening, and in that the first opening assigned to the free end lies opposite of the second opening in an inserting direction of the functional part.

With respect to the functional part, the above-defined objective is attained in that the flat region has two legs that extend approximately parallel to one another and/or in that a functional section is formed on both sides of the engagement section and/or in that the functional section is designed in the form of-an information carrier and/or in that the functional section is designed so as to include an obtuse angle with the insertion section and/or in that the functional section has an electronic element.

In addition to a predefined alignment of the functional part to be inserted, the elongate rectangular cross section of the passage opening also makes it possible to realize an anti-rotation lock of the functional part in the inserted position. This is achieved, in particular, by designing the functional part with a flat region that is adapted to the cross section of the passage opening.

The width of the passage opening and preferably also the corresponding width of the flat region of the functional part may correspond to approximately 4-times to 8-times, furthermore to approximately 5-times to 7-times or approximately 6-times, the cross-sectional height of the passage opening or the height of the flat region viewed transverse thereto.

The passage opening, which is respectively provided on or in the grip sleeve in the region of the free end and forms a mounting region, advantageously provides the option of a selective arrangement of a functional part on the grip sleeve. For example, a grip sleeve equipped with such a passage opening can be provided with different functional parts, wherein the plug-type mounting of the functional part in the passage opening preferably can be chosen in such a way that the functional part can be exchanged as needed by disengaging the plug-type mounting.

The hand-held tool initially may be a hand-held tool that only has a single grip region. This concerns, for example, a knife or a screwdriver.

However, the hand-held tool may also be designed with two tool parts that are arranged so as to intersect one another in a joint region, wherein each tool part forms the working region on one side of the joint region and the grip region on the other side. In this case, each grip region may be respectively arranged in a first and a second grip sleeve.

Such a hand-held tool typically is realized in the form of pliers or scissors.

In a hand-held tool with two grip regions and two corresponding grip sleeves, it would optionally be possible that only one of the two grip sleeves of the hand-held tool is provided with a passage opening of the above-described type in order to realize the plug-type mounting of a functional part. With respect to a potential manufacture of identical grip sleeves, it is in this case preferred that both grip sleeves have such a passage opening such that both grip sleeves can be provided with functional parts and optionally even with different functional parts. The passage opening of one of the grip sleeves serves for mounting a functional part whereas the passage opening of the other grip sleeve may also remain unused or accommodate a part that merely closes the passage opening.

It is furthermore preferred that the functional part as such cannot be directly or solitarily inserted into the passage opening. In fact, it is preferred that the functional part has a functional section, which preferably is also located outside the passage opening in the inserted state, and an insertion section, which is inserted into the passage opening entirely or to a significant degree in the operating state.

The passage opening may be formed in the grip sleeve itself, optionally in the first and/or second grip sleeve itself, in the form of a part of the grip sleeve that is not separable without being destroyed. Accordingly, it is furthermore preferred that the passage opening of the grip sleeve can already be taken into account and formed in the course of the manufacture of the grip sleeve, particularly in the course of a plastic injection molding process.

It is furthermore preferred that the passage opening is chosen and arranged in such a way that the hand-held tool provided with such a grip sleeve can also be safely used without a functional part being mounted in the passage opening.

It is furthermore preferred that a grip sleeve has, in a side view that shows the grip sleeve over its entire length, a taper that forms the free end. The first opening may already be formed in the taper or in any case form a transition to the taper. It is also particularly preferred that the first opening is visible in a view of the free end of the grip sleeve. It is located within the given contour of the grip sleeve in this view.

In the case of a hand-held tool with two grip sleeves, namely a first and a second grip sleeve, it is also preferred that the passage opening is formed on a side of the first and/or second grip sleeve that faces the other grip sleeve. This concerns the spatial arrangement of the tunnel-like passage opening, preferably within the grip sleeve itself. In a top view, in which both grip sleeves are visible over their entire longitudinal extent, the passage opening accordingly is arranged laterally of the grip region and assigned to the other grip sleeve. In hand-held tools of the type in question such as pliers or scissors, the passage opening therefore is particularly arranged in a region of the grip sleeves that preferably is not or not completely encompassed by the hand of the user.

The passage opening is designed continuously, with the first opening being assigned to the free end of the grip sleeve and the second opening pointing in the opposite direction. A passage opening in the region of the free end of the grip sleeve accordingly is formed for the plug-type retention of the functional part. In this case, the passage opening is open on both sides and has a tunnel-like design between the first and the second opening. The resulting passage direction of the passage opening, which also corresponds to an inserting direction of the functional part, preferably can be oriented essentially identical to an extent of the grip sleeve or an extent the grip region of the hand-held tool carrying the grip sleeve during normal use. It is furthermore preferred that the opening cross sections of the first and the second opening can be transferred into one another by an imaginary linear displacement in the passage direction. This imaginary transfer may be realized with or without penetration of a region of an opening wall of the passage opening, which protrudes into a corresponding cross section formed between the first and the second opening. Such an inwardly protruding region particularly may serve exclusively or additionally for mounting the functional part in the passage opening.

According to a preferred embodiment, the length of the passage opening viewed in the inserting direction may correspond to a multiple of the above-described height, e.g. to approximately 5-times to 20-times, furthermore to approximately 8-times to 12-times, the height.

According to a potential embodiment, an opening surface delimiting the height of the passage opening preferably can continuously transform into an adjacent surface section of the grip sleeve.

As already mentioned above, the passage opening preferably can be formed in the region of an inner surface of the grip sleeve, which respectively faces the opposite grip region or the opposite grip sleeve of the hand-held tool, such that a mounted functional part essentially is positioned on the inner side and/or the front side.

The passage opening may have a free cross section that is delimited by the opening wall over its length, wherein said free cross section corresponds to or is greater than the opening cross section of the first or second opening. This free cross section corresponding to the opening cross section of the first or second opening may be realized in an unrestricted manner over the length of the passage opening. In a linear projection in the direction of the length of the passage opening, the opening cross section of the first opening may be completely accommodated in the opening cross section of the second opening or the passage cross section of the second opening may be completely accommodated in the passage cross section of the first opening without a region of the wall of the passage opening protruding into this cross section over the entire length. However, a cross-sectional reduction, particularly in the form of an inwardly protruding region of the above-described type, preferably can also be formed at a certain location of the length of the passage opening, e.g. in order to exert a retaining effect upon a section of the functional part located within the passage opening in the inserted state. Vice versa, the functional part, namely the section of the functional part located in the passage opening in the inserted state, may also have a widening that in the inserted state leads to an elastic deformation of this section or a region of the opening wall that does not protrude inward and thereby causes or contributes to the desired retention.

The functional part may have an engagement section for being accommodated in the passage opening and a functional section. The engagement section preferably can be designed in the form of a flat region that is adapted to the cross section of the passage opening. The flat region preferably can also have a smaller enveloping surface than that corresponding to the opening cross section of the passage opening over part of its longitudinal extent. In a potential embodiment, the functional section may have a greater width and/or height than this engagement section or flat region.

According to a potential embodiment, the engagement section may be realized in the form of an insertion section. Furthermore, the insertion section of the functional part may be insertable into the passage opening starting from the first opening. Accordingly, a portion of the functional section preferably extends from the free end of the grip sleeve in the longitudinal direction of the grip sleeve.

The functional part may at least partially cover an end face of the free end of the grip sleeve in the inserted state of the functional part, particularly in conjunction with an inserting direction starting from the free end of the grip sleeve. The functional section may optionally form the end face of the free end of the grip sleeves completely or partially in the inserted position of the functional part. For example, such a functional section may optionally lie in a dimensionally adapted depression in the region of the free end of the grip sleeve in the inserted position.

The functional section may furthermore have an identification surface. Such an identification surface preferably can be formed on the outer side of the functional section. The identification surface may be a direct identification in the form of symbols or alphanumeric characters or a carrier for such symbols or characters. For example, the type of hand-held tool can be recognized based on the identification of the thusly designed functional part mounted in the grip sleeve, e.g. in the form of pictograms or color markings. Furthermore, such an identification surface may carry a name or a designation for a department, etc.

In a cross section, in which the inserting direction is illustrated in the form of a line, the identification surface may extend perpendicular or at an obtuse angle to the insertion section of the functional part. In this respect, an angle of approximately 90 degrees to 150 degrees, preferably an obtuse angle of approximately 135 degrees, may be formed, wherein such an obtuse angle furthermore may be formed, in particular, between the insertion section and an inner surface of a functional section facing away from the identification surface.

The identification surface may be exposed outward in the inserted state of the functional part. Accordingly, an externally visible identification surface can be formed on the free end of the grip sleeve in the mounted state of the functional part such that the identification surface can also provide a reference regarding the type of hand-held tool, for example, when the hand-held tool is accommodated in a pocket or the like such that its working region is not directly visible.

The insertion section may be realized in the form of a one-piece leg or a one-piece lug-like formation. However, the insertion section may alternatively also have two legs that are spaced apart from one another transverse to an inserting direction. Both legs of the insertion section respectively penetrate or engage into the passage opening in the course of an insertion process.

The plug-type mounting of the functional part can be achieved by inserting the insertion section into the passage opening without a free end of the insertion section protruding beyond the opening lying opposite of the insertion opening. The insertion section may also be designed in such a way that it definitely protrudes beyond the opposite opening, e.g. in order to allow a detent retention in the region of the opening edge of the passage opening.

Furthermore, a leg of the insertion section-preferably both legs in a two-part design of the insertion section- preferably can be provided with a detent formation. Such a detent formation may be realized in the form of a preferably end-side thickening relative to the section of the insertion section extending in the region of the passage opening in the inserted position, wherein said detent formation optionally has a control slope in order to deflect the leg or the insertion section into an overrun position during the course of the insertion. Once the inserted position is reached, the detent formation preferably snaps back into the engagement position behind the opening edge automatically due to a spring restoring force resulting from the material chosen for the insertion section in order to thereby lock the functional part.

The insertion section of the functional part may also be insertable into the passage opening starting from the second opening. In this context, it is also possible to realize a combination, in which a portion of the functional part is inserted into the passage opening from the first opening and a portion of the functional part is inserted into the passage opening from the second opening.

According to a potential embodiment, a functional part that is inserted starting from the second opening may protrude outward beyond the first opening. This may result in a protruding position of the corresponding end region of the functional part beyond an end face of the free end region of the grip sleeve. This end region may be the above-described functional section. For example, such a freely protruding region (functional section) may furthermore have an opening for suspending the hand-held tool, e.g. on a hook or on a belt. Furthermore, a thusly protruding portion of the functional part may also serve, for example, as a measuring instrument or as a lamp.

In a cross section viewed in the passage direction, the functional part may be designed in an essentially U-shaped manner in an extent perpendicular to the passage direction, wherein a first leg penetrates the passage opening and a second leg rests on the outside of the grip sleeve in the inserted position. In this case, a U-crosspiece of the functional part connecting the two legs preferably comprises a section of the grip sleeve that partially delimits the second opening. The first leg preferably can have a length that allows a protrusion of the first leg beyond an end face of the grip sleeve in the region of the free end.

If the functional part has a U-shaped cross-sectional design, the legs of the functional part particularly may have different widths-viewed transverse to an inserting direction. In this context, one leg may have a width that corresponds, for example, to 1.1-times to 1.5-times, furthermore to approximately 1.2-times to 1.3-times, the width of the other leg.

It is preferred that only the leg with the smaller width can be inserted into the passage opening. The leg with the smaller width may be an inner leg of the functional part-viewed from the grip sleeve. An outer, second leg may form the functional section in this case.

In another embodiment, the functional part may also be composed of two parts or multiple parts and comprise a separable connection between the two or more parts. The connection may be realized, for example, in the form of a detent mechanism that preferably is engaged automatically when the functional part is arranged on the grip sleeve. It is furthermore preferred that this connection is in the inserted state located within the passage opening and therefore in a concealed region that is not accessible to the user, at least not in a nondestructive manner.

In an exemplary two-part design of the functional part, one portion of the functional part can be inserted into the passage opening from the first opening and the second portion of the functional part can be inserted into the passage opening from the second opening.

In another embodiment, the flat region of the functional part may have a rectangular cross section. This flat region preferably has an elongate rectangular cross section with a width that corresponds to approximately 4-times to 8-times, furthermore to approximately 5-times to 7-times or approximately 6-times, the cross-sectional height of the flat region viewed transverse thereto. It is furthermore preferred that the cross section of the flat region is adapted to the cross section of the passage opening of the mounting recess.

The flat region may have two legs that extend approximately parallel to one another. The legs delimit the preferred rectangular cross section of the flat region in a section transverse to the longitudinal extent.

In a preferred embodiment, the legs extend in the longitudinal direction of the flat region or in the inserting or passage direction in a rod-like manner.

One or both legs may have a detent formation, e.g., in order to allow locking of the functional part in the inserted position. In this case, the detent formation may be arranged, for example, in the region of a free leg end.

According to a potential embodiment, the functional section may be realized in the form of a loop. In this way, the functional part can serve, for example, as a means for suspending the hand-held tool. Furthermore, it would also be possible, for example, to place a retaining band or the like through the loop.

The functional section may also be realized in the form of an identification carrier. The identification carrier may be inscribable or already provided, for example, with an inscription or with symbols by the manufacturer.

Furthermore, the functional section may also be an electronic element such as a lamp or a strain gauge.

In another embodiment, the functional section may have a larger cross section than the flat region. In this context, the functional section may have a width that corresponds, for example, to approximately 1.2-times to 2.5-times or more and up to 5-times the width of the flat region. A height of the functional section viewed perpendicular to the width furthermore may correspond, for example, to approximately 2-times to 10-times or more and up to 20-times the height of the flat section.

The functional section essentially may be realized in the form of a plastic section. The plastic used in this case may be a hard plastic.

According to a potential embodiment, the engagement section may in contrast be realized metallically, e.g. in the form of a wire hanger part or a sheet metal part.

The end of a metallic engagement section may be overmolded, for example, with plastic in order to form the functional section.

It would also be possible to form two functional sections. For example, such a functional part may be provided on both sides on the end of the engagement section, wherein the functional sections are separated from one another by the engagement section in a longitudinal direction of the functional element.

Furthermore, the functional part may also be realized, for example, in the form of an opening spring.

With respect to additional or alternative characteristics of the functional part, the preceding description regarding the characteristics of the hand-held tool apply analogously for their allocation in the claims. With respect to the disclosure, the ranges or value ranges or multiple ranges indicated above and below also include all intermediate values, particularly in 1/10 increments of the respective dimension, but optionally also dimensionless. For example, the disclosure of 90 degrees to 150 degrees also includes the disclosure of 90.1 to 150 degrees, 90 to 149.9 degrees, 90.1 to 149.9 degrees etc., and the disclosure of 3-times to 10-times also includes the disclosure of 3.1-times to 10-times, 3-times to 9.9-times, 3.1-times to 9.9-times etc. The respective disclosure may on the one hand serve for defining a lower and/or upper limit of a cited range, but alternatively or additionally also for disclosing one or more singular values from a respectively indicated range.

### BRIEF DESCRIPTION OF THE DRAWINGS

The invention is described in greater detail below with reference to the attached drawings that, however, merely show an exemplary embodiment (exemplary embodiments). A component, which is described with reference to one of the exemplary embodiments and not replaced with a different component in another exemplary embodiment, is therefore also described as a potentially existing component in this other exemplary embodiment. In the respective drawings:

FIG. 1 shows a perspective view of a hand-held tool in the form of pliers with a passage opening for a functional part formed on a grip sleeve of the hand-held tool;

FIG. 2 shows a view of the hand-held tool according to the arrow II in FIG. 1;

FIG. 3 shows a side view of the hand-held tool according to the arrow III in FIG. 2;

FIG. 4 shows an enlarged detail of the region IV in FIG. 1;

FIG. 5 shows a detailed view according to the arrow V in FIG. 2;

FIG. 6 shows a section according to the line VI-VI in FIG. 2;

FIG. 7 shows a section according to the line VII-VII in FIG. 3;

FIG. 8 shows a perspective view of a functional part according to a first embodiment;

FIG. 9 shows a view of the functional part according to the first embodiment;

FIG. 10 shows a rear view of the functional part;

FIG. 11 shows a side view of the functional part;

FIG. 12 shows a perspective detail view corresponding to FIG. 4 after the plug-type mounting of the functional part according to FIG. 8 in the passage opening of the grip sleeve;

FIG. 13 shows a sectional view according to FIG. 6 with an inserted functional part according to FIG. 8;

FIG. 14 shows a sectional view according to FIG. 7, namely also with an inserted functional part according to the first embodiment;

FIG. 15 shows a perspective view of a functional part according to a second embodiment;

FIG. 16 shows a view of the functional part according to the second embodiment;

FIG. 17 shows a side view of the functional part;

FIG. 18 shows a front view of the functional part;

FIG. 19 shows another perspective detail view corresponding to FIG. 4 after the plug-type mounting of the functional part according to FIG. 15;

FIG. 20 shows a sectional view according to FIG. 6 with an inserted functional part according to FIG. 15;

FIG. 21 shows a sectional view according to FIG. 7 with an inserted functional part according to FIG. 15;

FIG. 22 shows a sectional view according to FIG. 7 with an inserted functional part according to a third embodiment;

FIG. 23 shows a view according to FIG. 2 concerning a hand-held tool with a functional part according to FIG. 22;

FIG. 24 shows another perspective detail view corresponding to FIG. 4 after the plug-type mounting of a functional part according to a fourth embodiment;

FIG. 25 shows another sectional view corresponding to FIG. 7 after the plug-type mounting of a functional part according to a fifth embodiment;

FIG. 26 shows a schematic and partially sectioned view of a two-piece functional part according to a sixth embodiment;

FIG. 27 shows a sectional view corresponding to FIG. 7 after the plug-type mounting of the functional part according to FIG. 26;

FIG. 28 shows a perspective detail view essentially corresponding to FIG. 4 with the arrangement of a functional part according to another embodiment;

FIG. 29 shows a longitudinal section along the line XXIX-XXIX in FIG. 28;

FIG. 30 shows a section along the line XXX-XXX in FIG. 29 prior to the insertion of the functional part;

FIG. 31 shows a sectional view corresponding to FIG. 30 after the insertion of the functional part;

FIG. 32 shows the functional part according to the embodiment in FIG. 28 in the form of an individual perspective view;

FIG. 33 shows another view corresponding to FIG. 4 concerning another embodiment of a functional part;

FIG. 34 shows a longitudinal section along the line XXXIV-XXXIV in FIG. 33;

FIG. 35 shows the functional part according to the embodiment in FIG. 33 in the form of an individual perspective view;

FIG. 36 shows another perspective detail view essentially corresponding to FIG. 4 with the arrangement of a functional part according to another embodiment;

FIG. 37 shows a longitudinal section along the line XXXVII-XXXVII in FIG. 36;

FIG. 38 shows the functional part according to the embodiment in FIG. 36 in the form of an individual perspective view;

FIG. 39 shows a side view of a hand-held tool in the form of a cable stripping knife with a functional part arranged thereon; and

FIG. 40 shows a side view of a hand-held tool in the form of a screwdriver with a functional part arranged thereon.

### DESCRIPTION OF THE EMBODIMENTS

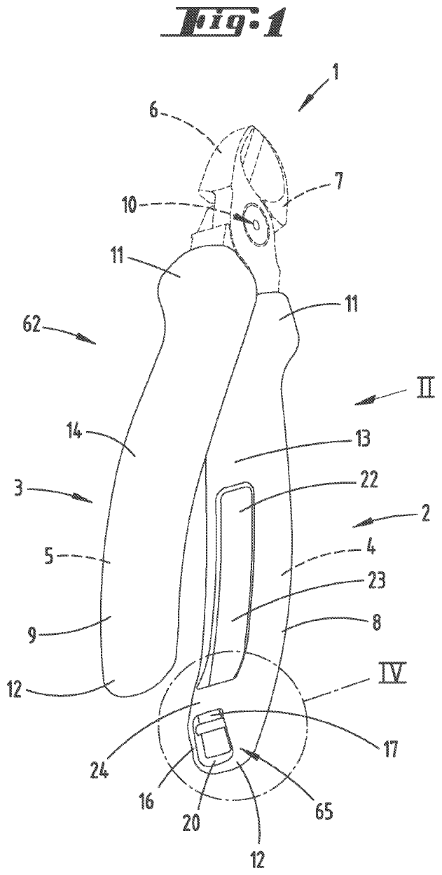

A hand-held tool 1 in the form of pliers, particularly in the form of side-cutting pliers, is initially described with reference to FIG. 1. However, the following specifications not only apply to a hand-held tool of this type, but particularly also to other pliers such as flat nose pliers, water pump pliers, universal pliers, wrench grippers or the like and, for example, to scissors such as household scissors or pruning shears. The specifications regarding the design of a grip sleeve and/or a functional part likewise apply to a hand-held tool with only one grip region such as a knife or a screwdriver.

The hand-held tool 1 has two tool parts 2, 3 that are arranged so as to intersect one another in a joint region 10. In this case, each tool part 2, 3 has a grip region 4, 5 that transforms into a working region 6, 7 on the other side of the intersecting and joint region. The working regions 6 and 7 form cutting edges in the exemplary embodiment of the hand-held tool 1 illustrated in FIG. 1.

The aforementioned tool parts 2, 3 are sometimes also referred to as tool halves. In this context, it does not matter if each tool half forms exactly half of the tool, but rather a part that complements the other part, particularly with respect to the grip region, so as to form the complete tool. The tool part also may not be designed continuously, but rather act upon, for example, a displaceable jaw via a lever transmission, particularly in the case of so-called wrench grippers (see, for example, EP 0 421 107 A2).

The grip region 4 and the working region 6 form the tool part 2; the grip region 5 in the working region 7 form the tool part 3.

Each grip region 4, 5 preferably is encompassed by a grip sleeve 8, 9. This preferably concerns respective sleeves that are manufactured of a plastic material and optionally formed directly on the tool parts 2, 3 in an injection molding process. Known solutions propose the separate manufacture of the grip sleeves 8, 9 in a plastic injection molding process, optionally in a two-component or multi-component plastic injection molding process. These grip sleeves 8, 9 can be pushed over the grip regions 4, 5 in their longitudinal direction L. In a tool part that consists of a plastic material in its entirety or at least in the area of the grip region, a grip sleeve 8, 9 may also be realized integrally with the grip region.

Furthermore, the grip sleeves 8 and 9 preferably are designed identically and respectively have an end 11 that faces the working region 6, 7, if applicable the joint region 10, and a free end 12 that faces away from the joint region 10.

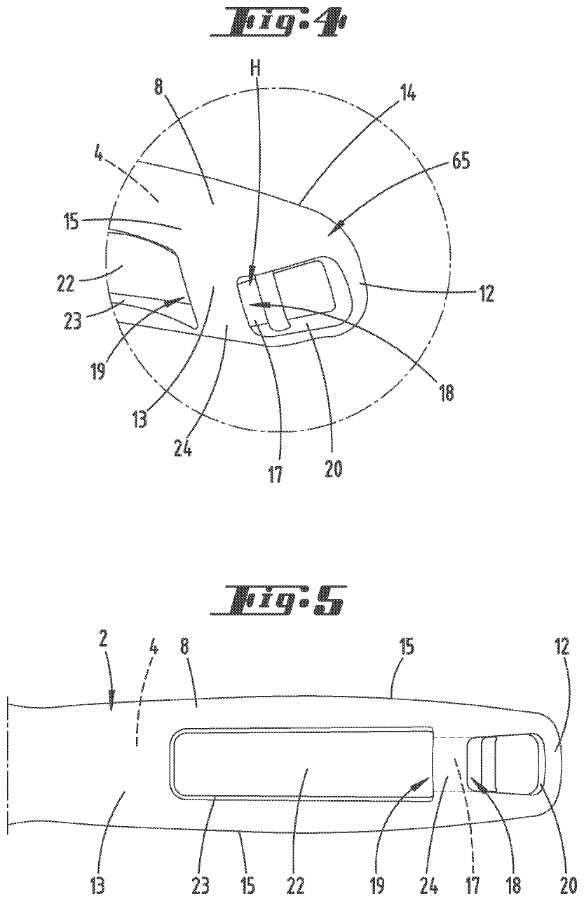

In their assigned position on a hand-held tool 1 with two tool parts, the grip sleeves 8 on the grip regions 4 and 5 of the hand-held tool 1 have inner surfaces 13 that face one another and outer surfaces 14 that face away from one another, as well as lateral surfaces 15 that connect the respective inner surface 13 to the associated outer surface 14 (see, in particular, the cross-sectional view in FIG. 6).

A plane E, which is aligned transverse to a center plane M of the hand-held tool 1 extending through the rotational axis x in the joint region 10, can be observed in the region of the free ends 12 of the grip sleeves 8-referred to a closed position of the hand-held tool according to FIG. 2 (see FIG. 2). An identical observation is also possible with respect to a grip sleeve of a hand-held tool according to FIG. 39 or 40, wherein the plane E is in this case formed perpendicular to a center plane M of the corresponding hand-held tool.

An end face 16 of the grip sleeve 8, 9 essentially extends from this plane E in the direction of the joint region 10 in an ascending manner, preferably at an acute angle α, for example, of approximately 30 to 60 degrees, furthermore approximately 45 degrees.

A mounting recess H, which preferably is realized in the form of a passage opening 17 and serves for the plug-type mounting of the functional part F, is arranged on the free end 12 formed by a taper 65 of the grip sleeve 8 in the region of the inner surface 13 or, in a hand-held tool according to FIGS. 39 and 40, in the region of a lateral surface. According to the cross-sectional view in FIG. 6, in particular, the passage opening 17 may lie in complete overlap with the grip region 4, 5 in a projection of the passage opening 17 and the assigned grip region 4, 5 into a common plane, e.g. the center plane M.

Viewed from the free end 12, it preferably is possible to look through the entire passage opening 17 that preferably extends essentially linearly in an inserting direction r.

The passage opening 17 preferably is designed in a slot-like manner, furthermore with a preferably elongate rectangular cross section that, in a cross section transverse to a longitudinal extent L of the grip sleeve 8, 9 according to the illustration in FIG. 6, has a width a and a height b extending perpendicular thereto. The width a of the passage opening 17 may correspond to approximately 0.3-times to 0.7-times, furthermore to approximately 0.5-times, the greatest width c of the grip sleeve 8 between the lateral surfaces 15 viewed in the same direction, wherein said width preferably also corresponds to approximately 4-times to 8-times, furthermore to approximately 6-times, the height b of the passage opening 17, and wherein said height b may according to another preferred embodiment approximately correspond to 0.05-times to 0.2-times, furthermore to approximately 0.1-times, a length d of the passage opening 17. Accordingly, the width c preferably is greater than the width a.

The passage opening 17 has a first opening 18 that is assigned to the free end 12 and a second opening 19 that points in the direction of the joint region 10. The first opening 18 is assigned to the region of the taper 65 of the grip sleeve 8.

The first opening 18 may form a transition of the passage opening 17 into a depression 20 that respectively starts from the end face 16 or the face plane defined by the end face 16.

In another embodiment, the height b of the passage opening 17 with defined opening surface 21, which can also be referred to as the bottom surface of the passage opening 17, preferably is realized such that it transforms from an associated region of the outer surface of the grip sleeve, particularly the inner surface (or lateral surface) 13, in a continuous manner, i.e. preferably without an offset in the direction of the height of the passage opening 17. This surface may be formed directly by the inner surface 13 or alternatively by a bottom surface 22 of a depression 23 that starts from the inner surface 13 as shown (see FIG. 7).

Furthermore, the slot-shaped passage opening 17 respectively is delimited laterally and opposite to the opening surface 21 by a bridge section 24 that preferably is realized integrally and uniformly in material with the grip sleeve 8, 9, wherein said bridge section as a whole transforms fluently into the contour of the region of the grip sleeve 8, 9 surrounding the grip region 4, 5 with respect to its outer contour (see FIG. 6).

The first opening 18 may be significantly spaced apart from the free end 12 due to the described acutely angled alignment of the end face 16 of each grip sleeve 8, 9. Nevertheless, the first opening 18 forms a partial region of the end face of the grip sleeve 8, 9 in a view of the free end in the direction of the center plane M.

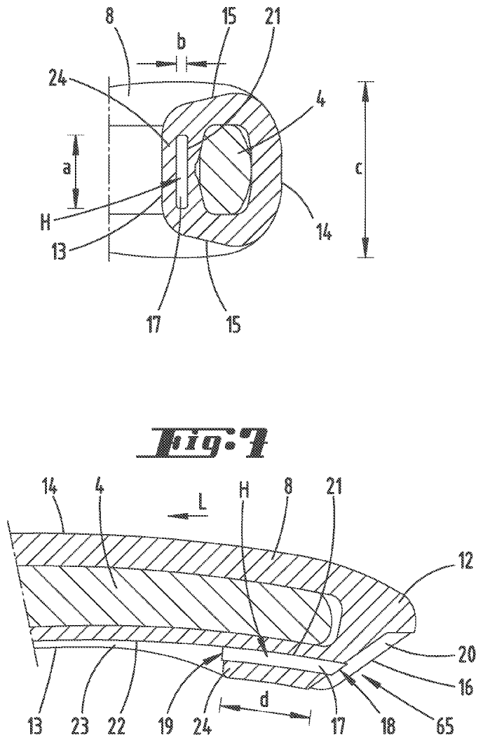

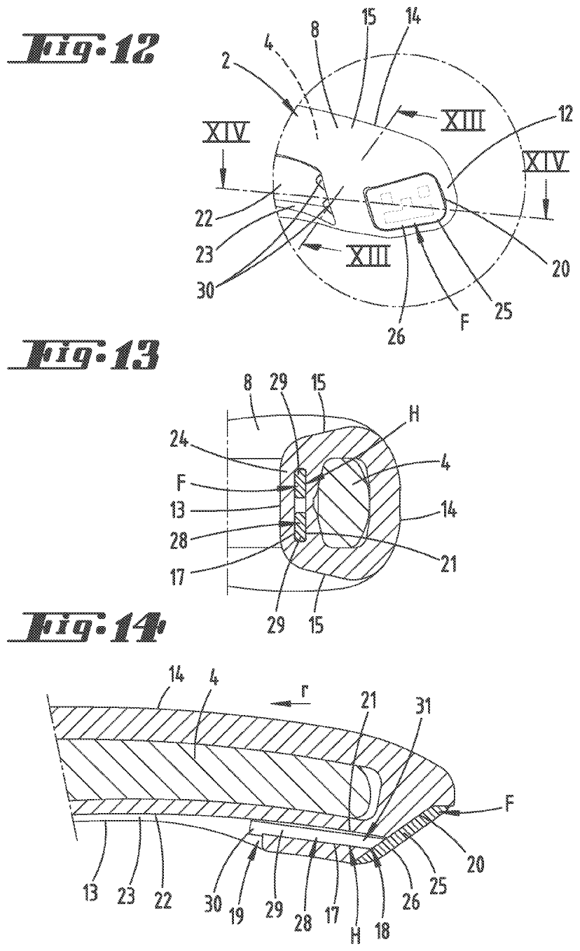

Different functional parts F preferably can be mounted in the passage opening 17. FIGS. 8 to 14 show a first embodiment of a functional part F, as well as the plug-type arrangement on the grip sleeve. This functional part F preferably is realized in the form of an injection-molded plastic part.

The functional part F according to the first embodiment initially has an essentially plate-shaped functional section 25, the shape of which preferably is adapted to the depression 20 in the region of the end face 16 of the grip sleeve with respect to its surface area, as well as its circumferential design and thickness. This functional section 25 forms an exterior identification surface 26, wherein an identification 27, which only is indicated schematically in FIGS. 8 and 12 and realized, for example, in the form of a pictogram, is printed on said identification surface or incorporated therein in the course of the manufacture of the functional part F.

An engagement section 31 is integrally formed on the functional section 25 on the side facing away from the identification surface 26. In this exemplary embodiment, this engagement section 31 forms an insertion section 28 and preferably has two legs 29 that are spaced apart from one another transverse to the inserting direction r. The width a′ of the entire insertion section 28 viewed transverse to the longitudinal extent preferably can essentially correspond to the width a of the passage opening 17. The legs 29 form a flat region 60 of the functional part F, which is adapted to the cross-sectional design of the passage opening 17.

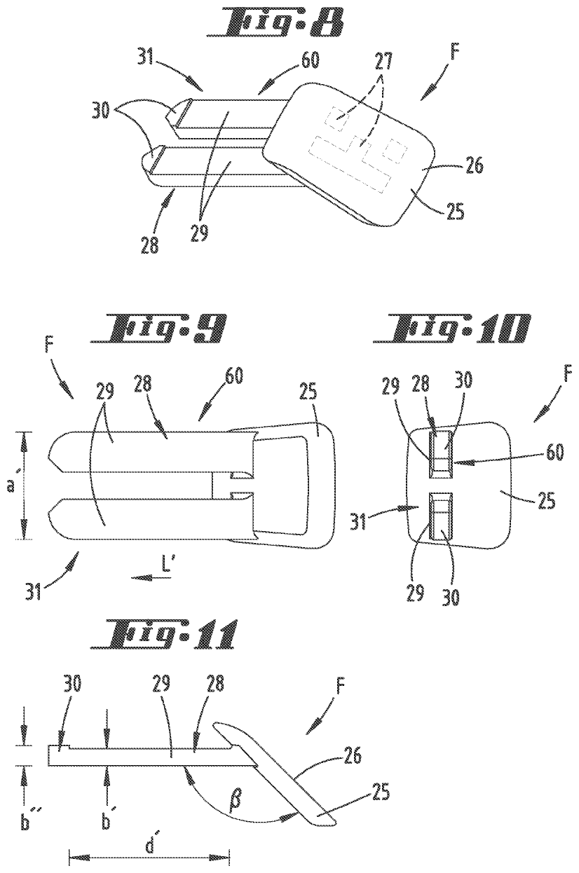

The legs 29 or the insertion section 28 formed by these legs preferably include/s an obtuse angle ß of approximately 120 to 150 degrees, furthermore approximately 135 degrees, with the functional section 25 (see FIG. 11).

Each leg 29 may initially have a section with preferably constant thickness b′ viewed perpendicular to the length of the legs 29, wherein said section starts from the functional section 25 and extends over a length d′, and wherein said thickness is chosen slightly smaller than the height b of the passage opening 17. The above-described length d′ of the leg section preferably is adapted to the length d of the passage opening 17.

A detent formation 30 is formed adjacent to the region of preferably constant thickness on to the end of the legs 29 facing away from the functional section 25, wherein the thickness b″ of said detent formation is greater than that of the above-described section and may essentially correspond to the height b of the passage opening 17.

The functional part F according to the first embodiment is inserted into the passage opening 17 with its insertion section 28 or its legs 29 starting from the first opening 18, furthermore essentially starting from the free end 12 of the grip sleeve 8, 9. The insertion section 28 moves through the slot-shaped passage opening 17 with its end-side detent formations 30 in the course of the insertion of the functional part F in the inserting direction r, wherein the detent formations 30 of the legs 29 subsequently engage behind the opening edge of the second opening 19 in a locking manner when the inserted position is reached (see FIG. 14).

The functional section 25 preferably lies completely in the depression 20 on the end face in this inserted position such that the identification 26 surface preferably is accommodated fluently in the surrounding surface of the end face 16 (see FIG. 12).

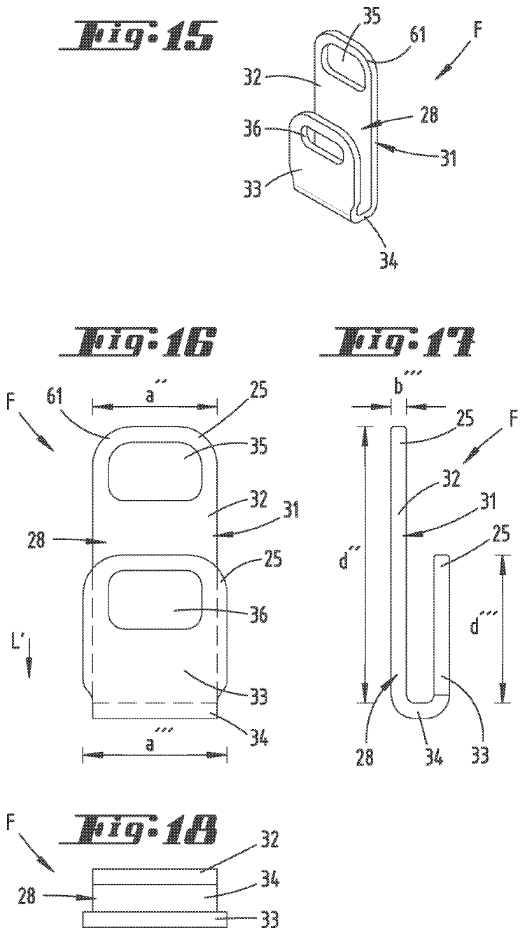

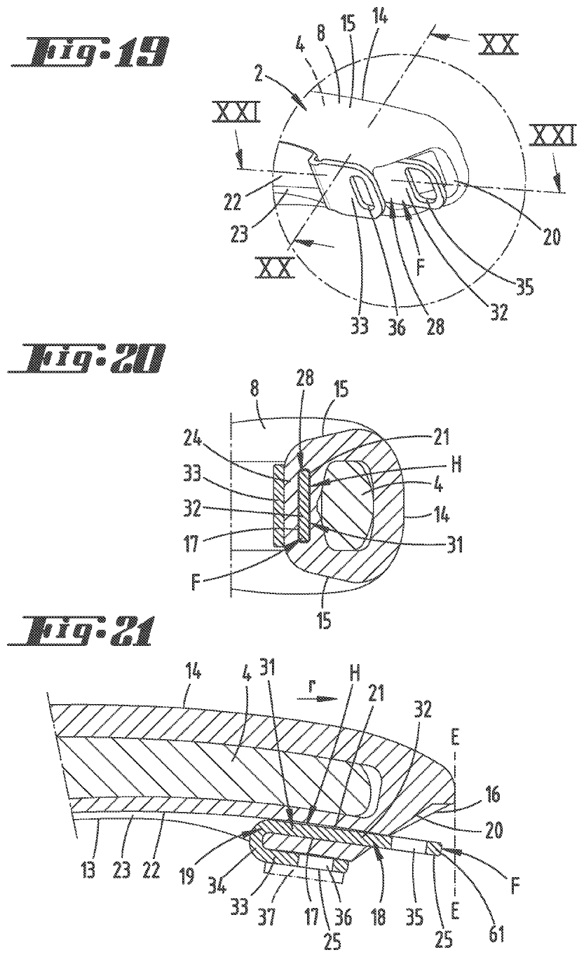

FIGS. 15 to 21 show a second embodiment of a functional part F, as well as its arrangement on the grip sleeve 8, 9. The functional part F according to the second embodiment may likewise be realized in the form of an injection-molded plastic part, but may in an alternative example also be realized in the form of a bent sheet metal part.

With respect to a cross section that is oriented in the inserting direction r or with respect to a correspondingly aligned side view according to FIG. 17, the functional part F essentially is designed in a U-shaped manner with a first leg 32, which forms the insertion section 28 in the form of a flat region 60 that is adapted to the passage opening 17, and a second leg 33, which extends parallel to and is spaced apart from the first leg 32. The two legs 32 and 33 are connected by a crosspiece 34.

The legs 32 and 33 have different lengths d″ and d′″ starting from the crosspiece 34. For example, the first leg 32 forming the insertion section 28 may have a length d′ that corresponds to approximately 1.5-times to 2.5-times, furthermore to approximately 2-times, the length d′″ of the second leg 33, wherein the length d″ of the first leg 32 preferably is chosen greater than the length d of the passage opening 17 and corresponds, for example, to approximately 1.5-times to 3-times, furthermore to approximately 2-times to 2.5-times, the length of the passage opening.

With respect to the above-described cross section or the side view according to FIG. 17, a constant thickness b′″ preferably is realized over the first leg 32, the crosspiece 34 and the second leg 33, wherein said thickness may essentially correspond to the height b of the passage opening 17.

In another embodiment, it is preferred that the width a″ of the first leg 32 forming the insertion section 28 is chosen smaller than the width a′″ of the second leg 33, wherein it is furthermore preferred that the width a″ of the first leg 32 essentially corresponds to the width a of the passage opening 17 such that the functional part F as a whole essentially can be mounted in the passage opening 17 in a clamped manner by means of the insertion section 28.

The width a′″ of the second leg 33 may correspond to approximately 1.05-times to 1.2-times, furthermore to approximately 1.1-times, the width a″ of the first leg 32.

The longer first leg 32 particularly is provided with a window-like aperture 35 in the region of its free end facing away from the crosspiece 34. According to the exemplary embodiment shown, the second leg 33 may also be designed with such an aperture 36. The functional sections 25 having the apertures 35 and 36 form loops 61.

In contrast to the above-described exemplary embodiment, the thusly designed functional part F preferably is inserted into the passage opening 17 in the inserting direction r starting from the second opening 19, wherein the insertion accordingly takes place in the direction of the free end 12 along the inner surface 13 or the bottom surface 12 of the depression 23. Due to the different widths of the legs 32 and 33, the first leg 32 is defined as the insertion section 28 to be inserted into the passage opening 17.

The functional part F preferably is inserted into the passage opening 17 until the leg 34 abuts on the facing bridge section 24 in a stop-limited manner. In this operating position, the shorter second leg 33 preferably rests on the outer side of the bridge section 24 and therefore on the grip sleeve 8, 9 and preferably extends in the inserting direction r over the entire length of the bridge section 24 up to approximately the base of the depression 20.

The first leg 32 extends through the passage opening 17 beyond the second opening 19 and preferably also beyond the depression 20, but preferably ends before it reaches the above-described plane E. Since the end face 16 or the depression 20 is inclined relative to the first leg 32 by an angle β, the aperture 35 forming the loop 61 is accessible such that the thusly designed functional part F can be used, for example, for suspending the hand-held tool 1 by respectively utilizing the aperture 35 or the loop 61.

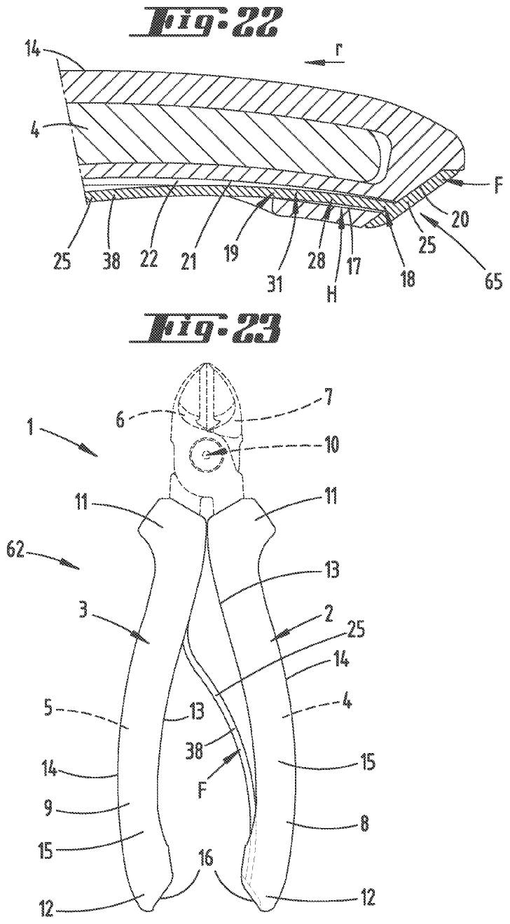

According to another exemplary embodiment, an information carrier 37 may also be arranged on a thusly designed functional part F, e.g. on the outer side of the second leg 33. The arrangement of such an information carrier 37, e.g. in the form of an RFID chip, in the form of an EAN code or also in the form of a tracking chip, is schematically indicated in FIG. 21 width dot-dash lines.

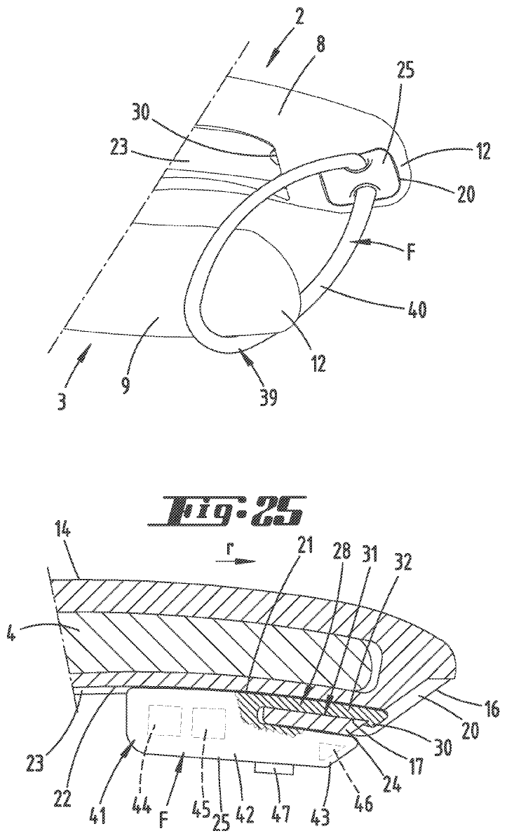

Furthermore, a functional part F according to the embodiment illustrated in FIGS. 22 and 23 may have or be a spring element 38, e.g. in the form of a leaf spring that functions as an opening spring. To this end, the functional part F essentially may be based, for example, on the above-described exemplary embodiment illustrated in FIGS. 8 to 11, wherein one of the legs 29 of the insertion section 28 furthermore is elongated such that this leg 29 with the spring element 38 freely protrudes beyond the second opening 19 in the inserted position and preferably is also supported on the facing inner surface 13 of the opposite grip region or the grip sleeve provided thereon. The spring section that freely protrudes beyond the second opening 19 forms the functional section 25.

According to FIG. 24, a functional part F that preferably is also based on the above-described first embodiment may have a functional section 25 that is realized in the form of a locking strap 39, wherein a loop 40 is to this end fastened on the functional section 25, e.g. on the outer side thereof. This fastening may be designed, for example, so as to be pivotable about a geometric pivoting axis.

According to another example, the functional part F may also be a preferably contactless strain gauge 41 (see FIG. 25). To this end, a housing 42 that comprises, in particular, electronics 44 and a battery 45, as well as a sensor unit 46, may have a cantilever arm that is designed in the form of a leg 32 for passing through the passage opening 17, wherein said cantilever arm may have a detent formation 30 on its end. The bridge section 24 is encompassed together with a housing section 43 similar to the arrangement of the functional part F according to the second embodiment while being supported on the bridge section 24, wherein an inserting direction r for fixing the strain gauge 41 on the grip sleeve 8, 9 may be oriented from the second opening 19 in the direction of the first opening 18. The function of the strain gauge 41 can be initiated or tested by means of a pushbutton 47 protruding beyond the housing 42.

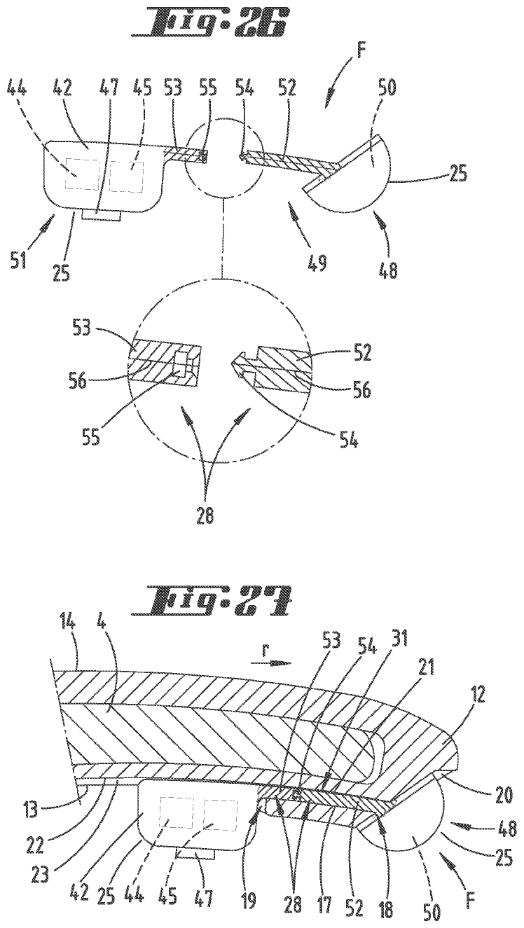

FIGS. 26 and 27 show a two-piece functional part F. This may concern an LED light 48 that can be fixed on the grip sleeve 8, 9 as shown. In this example, a portion 49 of the functional part F is connected, for example, to the luminous body 50 forming a first functional section 25 and the other portion 51 may be connected to a housing 42 forming a second functional section 25, wherein the electronics 44 and a battery 45 are accommodated, for example, in said housing 42. Furthermore, a pushbutton 47 for switching on the luminous body 50 may be provided on the portion 51.

Both portions 49 and 51 or functional sections 25 are provided with leg sections 52 and 53, wherein one leg section 52 may have a plug-in projection 54 and the other leg section 53 may have a correspondingly adapted plug-in receptacle 55 (see enlarged detail in FIG. 26).

The portion 49 having the luminous body 50 is inserted into the passage opening 17 through the first opening 18 with its leg section 52 whereas the second portion 51 having the housing 42 is inserted with its leg section 53 from the second opening 19, wherein an interlock of the leg sections 52 and 53 is achieved within the passage opening 17 due to the insertion of the plug-in projection 54 into the plug-in receptacle 55. The thusly designed functional part F subsequently is fixed on the grip sleeve 8, 9. The leg sections 52 and 53 jointly form the insertion section 28 or the engagement section 31 in this case.

Stranded wires 56 routed through the leg sections 52 and 53 are electrically connected in this interlocked position via the plug-in projection 54 and the plug-in receptacle 55 such that an electrical connection between the portions 49 and 51 is achieved.

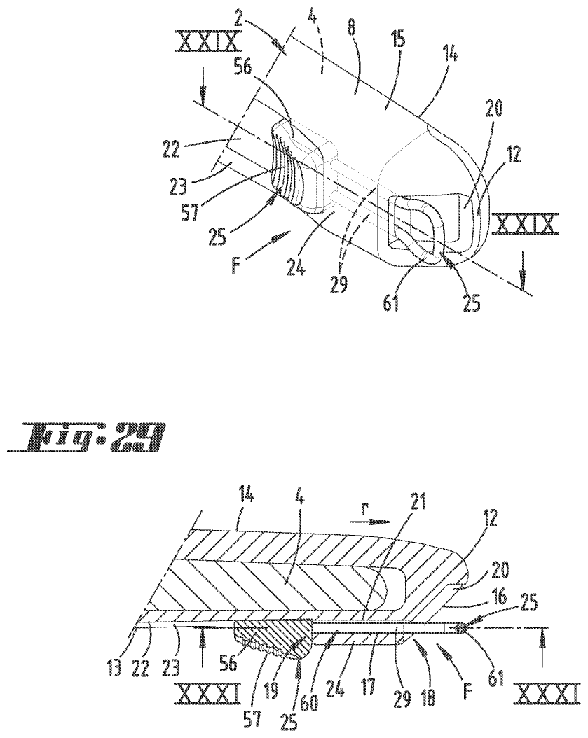

Other alternative options for fastening the functional part F in the passage opening 17 or by utilizing the passage opening 17 on the grip sleeve 8, 9 may be realized, for example, in the form of a rotary coupling or a bayonet coupling. FIGS. 28 to 32 show another embodiment with a functional part F, which particularly can be inserted into the passage opening 17 in the inserting direction r from the second opening 19 of the passage opening 17.

In this case, the insertion section 28 is realized in the form of a wire hanger section 58 with two legs 29, which essentially extend parallel to one another in the inserting direction r, and an end-side functional section 25, which connects the legs 29 to one another and can be used, for example, as a loop 61 in the embodiment shown.

The legs 29 form a flat region 60 for interacting with the passage opening 17 in a plug-type manner.

The essentially U-shaped functional section 25 preferably has a width e that is chosen greater than the width e′ between the outer surfaces of the legs 29 pointing away from one another in the flat region 60. For example, the width e may correspond to approximately 1.2-times to 1.8-times, furthermore to approximately 1.5-times, the width e′ (see also FIG. 30).

The legs 29 are accommodated and mounted in a blocking part 56 in the region of their free ends facing away from the functional section 25, wherein said blocking part is in the inserted position supported on the edge region surrounding the first opening 19 and thereby limits the insertion depth of the functional part F.

The blocking part 56 may be a plastic part. For example, the free ends of the legs 29 may be overmolded with this plastic in order to realize the blocking part 56.

In a longitudinal section according to the illustration in FIG. 29, the blocking part 56 furthermore may be designed in a wedge-shaped manner with a wedge surface that extends in an ascending manner starting from the free end and is realized, for example, in the form of a trough-like thumb rest 57, wherein the functional part F can be moved into the passage opening 17 by utilizing said thumb rest with a thumb placed thereon.

The blocking part 56 may also be a functional section 25 of the functional part F and comprise, for example, an identification surface.

In the course of the insertion process, the end-side functional section 25 in the form of a loop 61 is initially pushed through the passage opening 17, wherein this functional section 25 can be pressed together as a result of its wire-shaped design such that this functional section can be pushed through the passage opening 17 despite the fact that its width is greater than the passage opening 17.

The width e″ of the passage opening 17 may simultaneously or alternatively be chosen smaller, preferably slightly smaller, than the width e′ in the flat region 60 or an adjacent greater width in the direction of the loop 61, but preferably smaller than the width e of the functional part F. A deformation of the elastic plastic may occur in the region of the wall of the passage opening 17, if applicable additionally or alternatively to the deformation of the legs of the functional part F, in the course of the insertion of the functional part F. This altogether results in the functional part F being clamped in the passage opening 17.

After the penetration of the first-outer-opening 18, the functional section 25 can once again restore itself due to the elastic resilience and engage behind the opening 18 in a locking manner. A restoration of the elastically deformable plastic material of the grip sleeve may alternatively or additionally occur in the region of the first opening 18. Subsequently, the functional part F is captured between the functional sections 25 (blocking part 56 and loop 61), which optionally are supported on the respective opening edges of the openings 18 and 19.

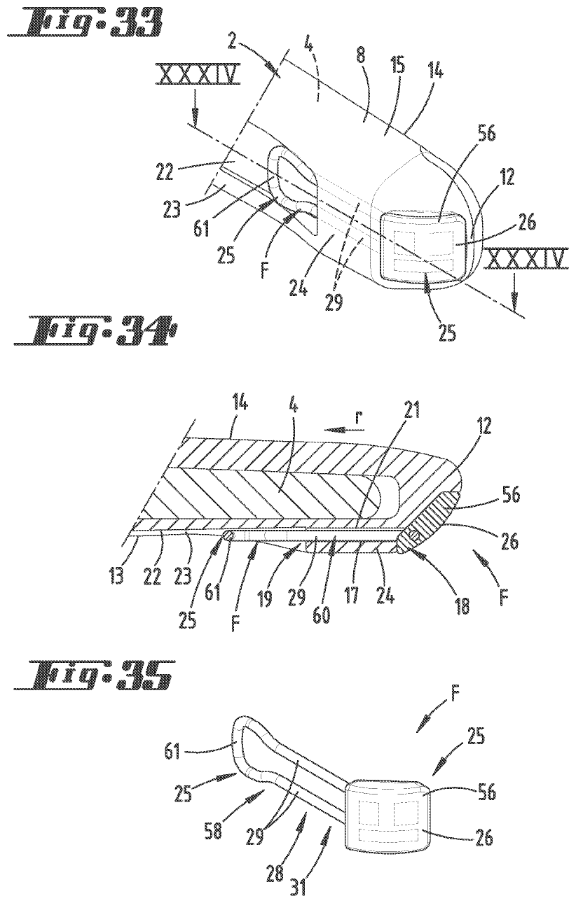

FIGS. 33 to 35 show an embodiment, in which the design, in particular, of the flat region 60 and a functional section 25 that, according to the above-described embodiment, forms a loop 61 consisting of a wire hanger section 58 results in an inserting direction r from the first opening 18 in the direction of the second opening 19, wherein said inserting direction accordingly starts from the end face 16 of the grip sleeve.

In this case, the region forming the loop 61 is also widened in comparison with the flat region 60 or the region delimited by the legs 29, respectively. The loop region is compressed with respect to its width and/or the passage opening 17 is elastically widened in the course of the insertion of this widened functional section 25 through the passage opening 17. The loop 61 or the corresponding functional section 25 or the elastically deformed plastic automatically restores itself when the loop 61 exits the second opening 19.

The blocking part 56, which preferably is realized in the form of an injection-molded plastic part and in this case also provided opposite of the loop 61, may be shaped in such a way that it abuts in the depression 20 on the face of the grip sleeve in the inserted position of this functional part F (see FIG. 34). An outwardly directed surface of the blocking part 56 that forms a second functional section 25 may provide, for example, an identification surface 26 of the type described above, for example, with reference to the embodiment illustrated in FIGS. 8 to 14.

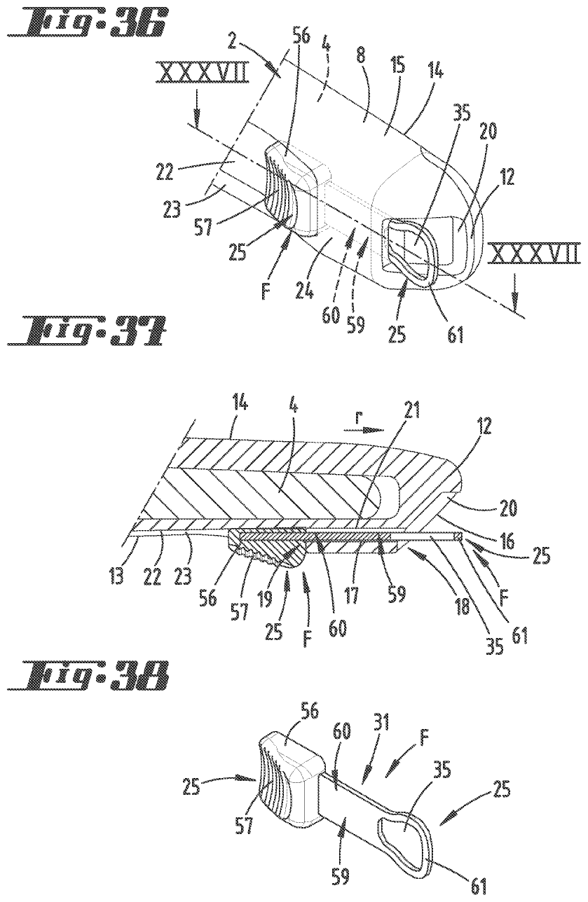

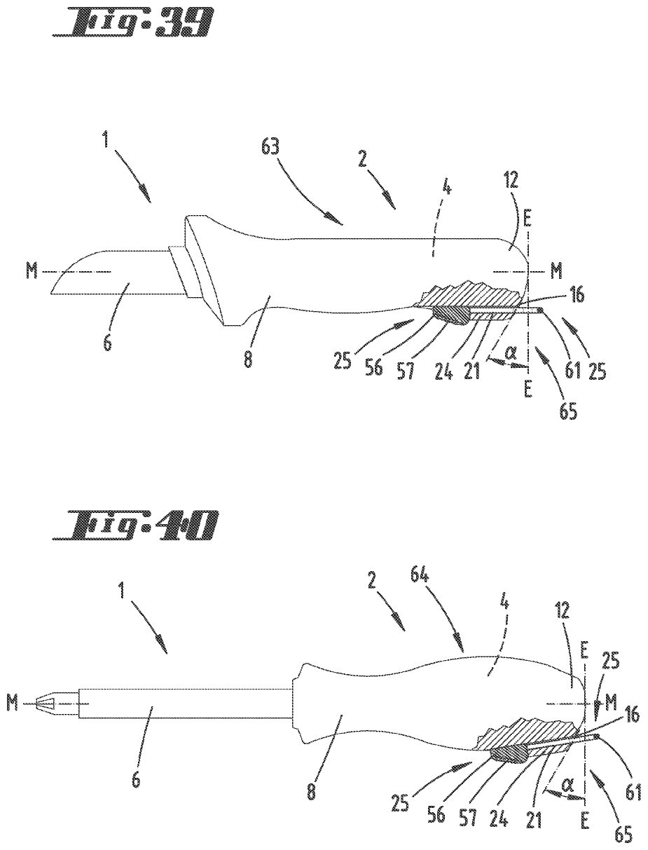

The functional part F of the embodiment illustrated in FIGS. 36 to 38 essentially is based on the above-described embodiment illustrated in FIGS. 28 to 32, but a sheet metal section 59 is provided in this case instead of the wire hanger section 58 that forms the legs 29 and the loop-like functional section 25.

This sheet metal section 59 is also provided with a flat region 60, which has a width e′ and extends in the passage opening 17 in the inserted position, wherein a comparatively widened loop-like functional section 25 with an aperture 35 is arranged adjacent to the end of said flat region. The preceding description of the embodiment illustrated in FIGS. 28 to 31 applies analogously with respect to the width e of the functional section 25 in relation to the width e′ or the width of the passage opening 17 viewed in the same direction, respectively.

On the side facing away from the functional section 25, the sheet metal section 59 is in this embodiment also mounted in a blocking part 56, which optionally forms another functional section 25.

The insertion likewise takes place starting from the second opening 19, wherein the functional section 25, the width e of which is greater than the opening width of the passage opening 17, can in this case also be resiliently compressed.

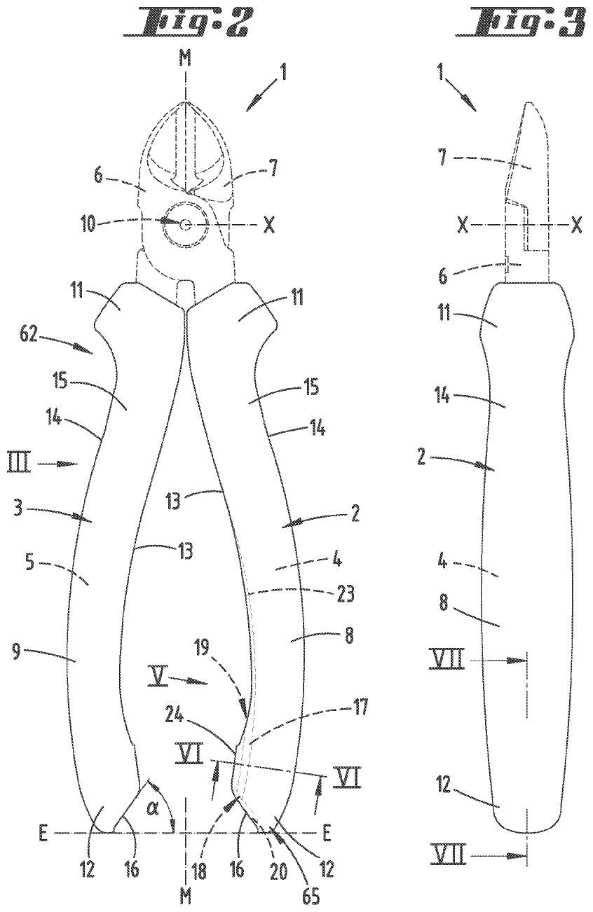

The functional parts F of the embodiments illustrated in FIGS. 28 to 38 have two functional sections 25, which preferably are spaced apart from one another and connected to one another by a flat region 60 that forms the engagement section 31 and is realized in the form of a wire hanger or sheet metal section. FIGS. 1 to 38 show exemplary embodiments of a hand-held tool in the form of pliers 62 with two tool parts 2 and 3 whereas the additional embodiments illustrated in FIGS. 39 and 40 concern hand-held tools 1 with only one tool part 2. The example illustrated in FIG. 39 shows a cable stripping knife 63. FIG. 40 shows a screwdriver 64.

The knife or screwdriver handle is respectively formed by a grip sleeve 8 that encompasses the grip region 4 of the tool part 2. The working region 6 is respectively formed by the knife blade or the screwdriver shaft only.

A functional part F can also be arranged on the end of the grip region 4 in this case. A passage opening 17, through which the functional part F according to the above-described embodiments can be inserted, is formed in the grip sleeve 8 on the free end 12.

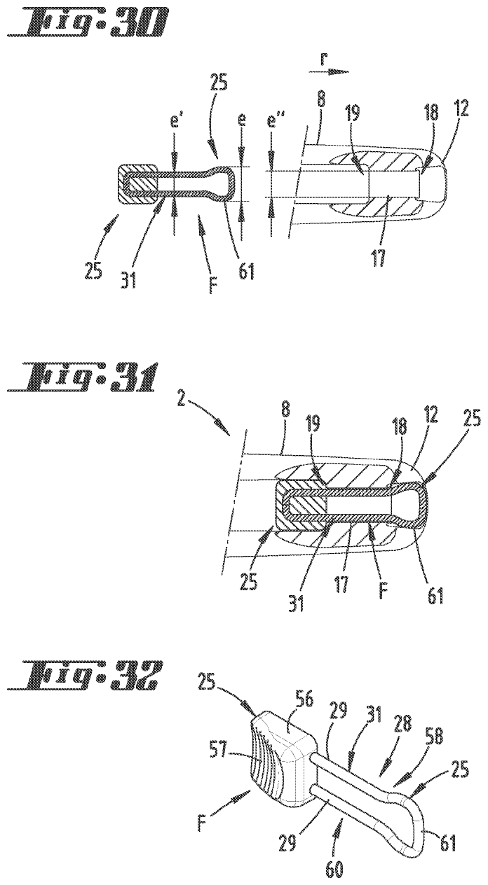

FIGS. 39 and 40 show a functional part F according to the embodiment illustrated in FIG. 31, but the arrangement, for example, of a functional part F according to FIG. 15, 24, 25, 26 or 34 is also conceivable.

### LIST OF REFERENCE SYMBOLS

1 Hand-held tool

2 Tool part

3 Tool part

4 Grip region

5 Grip region

6 Working region

7 Working region

8 Grip sleeve

9 Grip sleeve

10 Joint region

11 End

12 Free end

13 Inner surface

14 Outer surface

15 Lateral surface

16 End face

17 Passage opening

18 First opening

19 Second opening

20 Depression

21 Opening surface

22 Bottom surface

23 Depression

24 Bridge section

25 Functional section

26 Identification surface

27 Identification

28 Insertion section

29 Leg

30 Detent formation

31 Engagement section

32 First leg

33 Second leg

34 Crosspiece

35 Aperture

36 Aperture

37 Information carrier

38 Spring element

39 Locking strap

40 Loop

41 Strain gauge

42 Housing

43 Housing section

44 Electronics

45 Battery

46 Sensor unit

47 Pushbutton

48 LED light

49 Portion

50 Luminous body

51 Portion

52 Leg section

53 Leg section

54 Plug-in projection

55 Plug-in receptacle

56 Blocking part

57 Thumb rest

58 Wire hanger section

59 Sheet metal section

60 Flat region

61 Loop

a Width

a′ Width

a″ Width

a′″ Width

b Height

b′ Thickness

b″ Thickness

b′″ Thickness

c Width

d Length

d′ Length

d″ Length

d′″ Length

e Width

e′Width

r Inserting direction

x Rotational axis

E Plane

F Functional part

H Mounting recess

L Longitudinal direction

L′ Longitudinal direction

M Center plane

αAngle

βAngle

1. A hand-held tool (1) with a working region (6, 7) and a grip region (4, 5), wherein the grip region (4, 5) is arranged in a grip sleeve (8, 9), wherein the grip sleeve (8, 9) has an end (11) assigned to the working region (6, 7), as well as an opposite free end (12), and is configured to be provided with a functional part (F), wherein the grip sleeve (8, 9) furthermore has a passage opening (17) that extends in a longitudinal direction (L) of the grip sleeve (8, 9) and forms a first opening, which also has a free opening cross section in an unused state, and a second opening (18, 19), and wherein the functional part (F) is configured to be inserted into said passage opening in order to be mounted on the grip sleeve (8, 9), wherein the first and the second opening (18, 19) have a substantially elongate rectangular design with respect to a cross section transverse to a passage direction of the passage opening (17), and wherein the first opening (18) assigned to the free end lies opposite of the second opening (19) in an inserting direction of the functional part (F).

2. The hand-held tool according to claim 1, wherein two tool parts (2, 3) are provided and arranged so as to intersect one another in a joint region (10), wherein each tool part (2, 3) forms the working region (6, 7) on one side of the joint region (2, 3) and the grip region (4, 5) on the other side, and wherein each grip region (4, 5) is respectively arranged in a first and a second grip sleeve (8, 9).

3. The hand-held tool according to claim 2, wherein the hand-held tool (1) is pliers or scissors.

4. The hand-held tool according to claim 1, wherein the hand-held tool (1) is a knife or a screwdriver.

5. The hand-held tool according to claim 1, wherein the passage opening (17) is formed in the grip sleeve (8, 9) itself in the form of a part of the grip sleeve (8, 9) that is not separable without being destroyed.

6. The hand-held tool according to claim 2, wherein the passage opening (17) is formed on a side of the first and/or second grip sleeve (8, 9) that respectively faces the other grip sleeve (8, 9).

7. The hand-held tool according to claim 1, wherein the grip sleeve (8, 9) has in a side view a taper that forms the free end, and wherein the first opening (18) is formed in the taper.

8. The hand-held tool according to claim 1, further comprising the functional part (F), and wherein the functional part (F) has an engagement section (31) configured for being received in the passage opening (17) and a functional section (25).

9. The hand-held tool according to claim 8, wherein the engagement section (31) is in the form of an insertion section (28).

10. The hand-held tool according to claim 9, wherein the insertion section (28) of the functional part (F) is configured to be inserted into the passage opening (17) starting from the first opening (18) or the second opening (19).

11. The hand-held tool according to claim 8, wherein the functional section (25) at least partially covers an end face (16) of the free end (12) of the grip sleeve (8, 9) in the inserted state of the functional part (F).

12. The hand-held tool according to claim 8, wherein the functional section has an identification surface (26) or is designed in the form of a loop.

13. The hand-held tool according to claim 12, wherein the functional section has the identification surface and wherein the identification surface (26) extends in a cross section perpendicular or at an obtuse angle (β) to the insertion section (28) of the functional part (F).

14. The hand-held tool according to claim 12, wherein the functional section has the identification surface, and wherein the identification surface (26) is exposed outward in the inserted state of the functional part (F).

15. The hand-held tool according to claim 9, wherein the insertion section (28) has two legs (29) that are spaced apart from one another transverse to an inserting direction (r).

16. The hand-held tool according to claim 15, wherein one leg (29) of the two legs (29) has a detent formation (30).

17. The hand-held tool according to claim 9, wherein the insertion section (28) of the functional part (F) is configured to be inserted into the passage opening (17) starting from the second opening (19).

18. The hand-held tool according to claim 17, wherein the functional part (F) being inserted starting from the second opening (19) protrudes outward beyond the first opening (18).

19. The hand-held tool according to claim 17, wherein the functional part (F) being inserted starting from the second opening (19) protrudes outward beyond the first opening (18).

20. The hand-held tool according to claim 18, wherein the functional part (F) is in a cross section designed U-shaped, with a first leg and a second leg, wherein the first leg (32) penetrates the passage opening (17) and the second leg (33) rests on the outside of the grip sleeve (8, 9) in the inserted position.

21. The hand-held tool according to claim 20, wherein the first and second legs (32, 33) have a different width (a″, a′″).

22. The hand-held tool according to claim 21, wherein only the leg (32) with the smaller width (a″) can be inserted into the passage opening (17).

23. The hand-held tool according to claim 20, wherein the second leg (33) forms the functional section (25).

24. The hand-held tool according to claim 8, wherein the functional part (F) is composed of two or more parts and comprises a separable connection between the two or more parts.

25. The hand-held tool according to claim 24, wherein the connection is located within the passage opening (17) in an inserted state.

26. A functional part (F) for a detent connection with a grip region (4, 5) of a hand-held tool (1), wherein the functional part (F) has an engagement section (31) configured for engaging into a mounting recess (H) of the grip region (4, 5) and a functional section (25), and wherein the engagement section (31) is realized in the form of a flat region (60) that is adapted to a passage opening (17) with an essentially rectangular opening cross section, wherein the flat region (60) has two legs (29) that extend approximately parallel to one another and/or
wherein the functional section (25) is formed on both sides of the engagement section (31) and/or
wherein the functional section (25) is designed in the form of an information carrier and/or
wherein the insertion section (28) includes an obtuse angle of approximately 120 to 150° with the functional section (25) and/or
wherein the functional section (25) has an electronic element.

39. 27-39 (canceled)

40. The hand-held tool according to claim 8, wherein the functional part (F) has a spring element (38).

41. The functional part according to claim 26, wherein the flat region (60) has a rectangular cross section.

42. The functional part according to claim 26, wherein one or both legs (29) has or have a detent formation (30).

43. The functional part according to claim 26, wherein the functional section (25) has a larger cross section than the flat region (60).

44. The functional part according to claim 26, wherein the functional section (25) is in the form of a plastic section.

45. The functional part according to claim 26, wherein the engagement section (31) is formed metallically.

46. The functional part according to claim 26, wherein the functional section (25) comprises two functional sections (25).

47. The functional part according to claim 46, wherein the functional sections (25) are separated from one another by the engagement section (31) in a longitudinal direction (L′) of the functional part (F).

48. A hand-held tool with a functional part (F) according to claim 40.
